(19) United States
(12) Patent Application Publication
(10) Pub. No.: US 2023/0222719 A1
(43) Pub. Date: Jul. 13, 2023

(54) CUSTOMIZABLE MEMORABILIA SYSTEM

(71) Applicant: Charles Isgar, Scottsdale, AZ (US)

(72) Inventor: Charles Isgar, Scottsdale, AZ (US)

(21) Appl. No.: 18/174,726

(22) Filed: Feb. 27, 2023

Related U.S. Application Data
(63) Continuation of application No. 16/109,528, filed on Aug. 22, 2018, now abandoned.
(60) Provisional application No. 62/587,971, filed on Nov. 17, 2017.

(51) Int. Cl. G06T 11/60; G06F 40/186; G06F 3/0485; G09F 3/02

(52) U.S. Cl. CPC G06T 11/60; G06F 40/186; G06F 3/0485; G06T 2200/24; G09F 3/02

(57) ABSTRACT

A customizable memorabilia system is provided. The system includes a computer server having a memory storing memorabilia templates and ticketed experience data associated with the memorabilia templates. The system also includes a user computing device coupled to the computer server. The computer server may be programmed to receive from the user computing device a signal including E-ticket data, wherein the E-ticket data may include ticket code information. The computer server may also be programmed to automatically process the signal received from the user computing device and retrieve ticketed experience data corresponding to the E-ticket data. Using the ticketed experience data retrieved, the computer server may also be programmed to automatically generate and transmit to the user computing device for display a user interface for customizing a memorabilia template with customizable features, wherein the customizable features are customized for producing a memorabilia item including a physical item or a digital item.

### CROSS REFERENCE TO RELATED APPLICATION[S]

This application is a continuation of U.S. Pat. Application entitled “CUSTOMIZABLE MEMORABILIA SYSTEM,” serial number 16/109,528, filed Aug. 22, 2018, which claims priority to U.S. Provisional Pat. Application entitled “CUSTOMIZABLE EVENT TICKET SYSTEM,” serial number 62/587,971, filed Nov. 17, 2017, now pending, the disclosure of which is hereby incorporated entirely herein by reference.

### BACKGROUND OF THE INVENTION

### Technical Field

This invention relates generally to a memorabilia system and more particularly to a customizable memorabilia system for customizing and producing a memorabilia item from a digital ticket for a ticketed experience.

### State of the Art

The use of mobile computing devices, such as smartphones, is widespread. Ticketing companies, event organizers, venues, airlines and the like have capitalized on electronic ticketing by the wide use of smartphones and home printing. These electronic tickets are often provided as a bar code or the like that may be displayed on the smartphone and scanned by a ticket scanner at the venue or experience location to verify that the ticket is valid. This is typically utilized for various reasons including, but limited to, reduce cost, reduce tickets being lost, stolen or left behind, combat fraud, give more control over resale market to teams and to provide a more convenient delivery and sharing of tickets. Electronic tickets, however, lack the ability to provide a keepsake, memento, memorabilia or the like that were widely enjoyed in years past.

Accordingly, there is a need for customizable memorabilia system that allows a user to produce a memorabilia item for ticketed experience from an electronic ticket.

### DISCLOSURE OF THE INVENTION

The present invention relates to a customizable memorabilia system for customizing and producing a memorabilia item from a digital ticket for a ticketed experience.

An embodiment includes a customizable memorabilia system comprising: a computer server comprising a memory storing memorabilia templates and ticketed experience data associated with the memorabilia templates; and a user computing device coupled to the computer server, the computer server programmed to: receive from the user computing device a signal including E-ticket data, wherein the E-ticket data may include ticket code information; automatically process the signal received from the user computing device and retrieve ticketed experience data corresponding to the E-ticket data; using the ticketed experience data retrieved, automatically generate and transmit to the user computing device for display a user interface for customizing a memorabilia template with at least two customizable features located within the memorabilia template and at least one data element of the ticketed experience data automatically entered within the memorabilia template in one of the customizable features corresponding the at least one data element of the ticketed experience data, wherein the other customizable feature of the at least two customizable features is customized based on user determination for creation of the memorabilia item for the ticketed experience corresponding to the E-ticket data.

Another embodiment includes a customizable memorabilia system comprising: a computer server comprising a memory storing memorabilia templates and ticketed experience data associated with the memorabilia templates; and a user computing device coupled to the computer server, the computer server programmed to: receive from the user computing device a signal including E-ticket data, wherein the E-ticket data may include ticket code information; automatically process the signal received from the user computing device and retrieve ticketed experience data corresponding to the E-ticket data; using the ticketed experience data retrieved, automatically generate and transmit to the user computing device for display a user interface for customizing a memorabilia frame template with at least two customizable features located within the memorabilia frame template and at least one data element of the ticketed experience data automatically entered within the memorabilia template in one of the customizable features corresponding the at least one data element of the ticketed experience data, wherein the other customizable feature of the at least two customizable features is customized based on user determination for creation of the memorabilia item for the ticketed experience corresponding to the E-ticket data.

Another embodiment includes a customizable memorabilia system comprising: a computer server comprising a memory storing memorabilia templates and ticketed experience data associated with the memorabilia templates; and a user computing device coupled to the computer server, the computer server programmed to: receive from the user computing device a signal including E-ticket data, wherein the E-ticket data may include ticket code information; automatically process the signal received from the user computing device and retrieve ticketed experience data corresponding to the E-ticket data; using the ticketed experience data retrieved, automatically generate and transmit to the user computing device for display a user interface for customizing a memorabilia template with customizable features, wherein the customizable features are displayed as selectable features for user selection; and in response to receiving a signal of the user selected customizable features, automatically updating the memorabilia template with ticketed experience data in predetermined locations within the memorabilia template, wherein the computer server is programmed to initiate creation a memorabilia item for the ticketed experience corresponding to the E-ticket data from the customized memorabilia template.

The foregoing and other features and advantages of the present invention will be apparent from the following more detailed description of the embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a customizable memorabilia system in accordance with an embodiment;

FIG. 2A is a flow chart of programmed steps of a computer server of a customizable memorabilia system in accordance with an embodiment;

FIG. 2B is a flow chart of another set of programmed steps of a computer server of a customizable memorabilia system in accordance with an embodiment;

FIG. 3A is a view of a customizable memorabilia template for a theme park in accordance with an embodiment;

FIG. 3B is a view of a customizable memorabilia template for a sporting event in accordance with an embodiment;

FIG. 3C is a view of a customizable memorabilia template for a concert or music festival in accordance with an embodiment;

FIG. 4A is a view of an electronic frame for use with a customizable memorabilia system in accordance with an embodiment;

FIG. 4B is another view of an electronic frame for use with a customizable memorabilia system in accordance with an embodiment;

FIG. 4C is a view of a framed memorabilia item including a hard stock ticket produced using a customizable memorabilia system in accordance with an embodiment; and

FIG. 5 is a view of a mobile application operating as part of a customizable memorabilia system in accordance with an embodiment.

### DETAILED DESCRIPTION OF EMBODIMENTS OF THE INVENTION

As discussed above, embodiments of the present invention relate to a customizable memorabilia system for customizing and producing a memorabilia item from a digital ticket for a ticketed experience.

A hard stock ticket is a paper ticket for a theme park, sporting event, concert or other ticketed experience, typically printed on hard stock paper that is thicker and stronger than composition or notebook paper that was previously customary in the ticket business. Electronic tickets (“E-tickets”) include electronic tickets useable from a mobile computing device like a smartphone, printable electronic tickets, and the like. The move to E-tickets has several drawbacks. These drawbacks include depriving fans of the tangible proof that they attended a memorable visit to theme parks, a significant moment in sports history, music history and/or memorable moment of their life. Printouts of E-tickets are lacking because they are flimsy, are not being aesthetically pleasing, and lack sentimental value. This sentimental value is something people are willing to pay for, not just immediately but in the future as hard to come by tickets, or tickets to momentous events grow older, the value can increase dramatically. This trend is made apparent by some teams, performers, and the like moving to E-tickets exclusively. This problem is one that is expounded in the secondary markets where people are purchasing tickets through online vendors and receive and electronic ticket or a printable E-ticket.

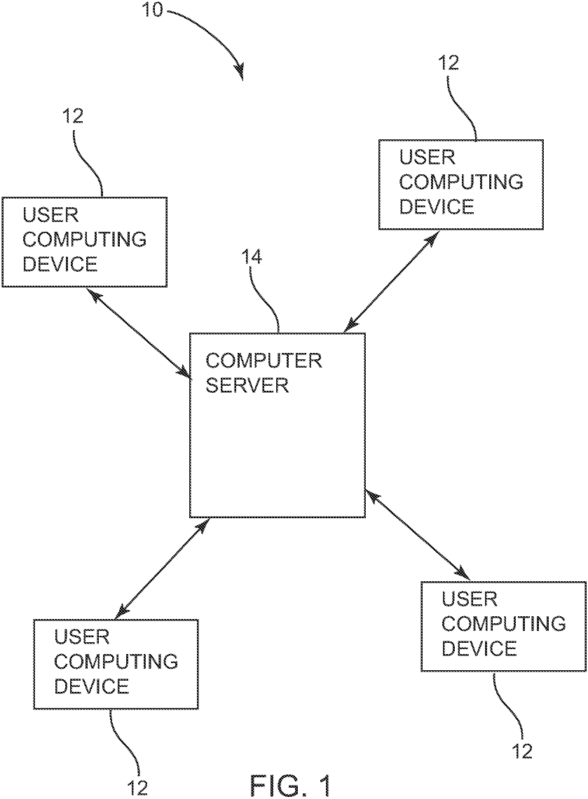

Referring to the drawings, FIG. 1 depicts an embodiment of a customizable memorabilia system 10. The system 10 may include user computing devices 12 and a computer server 14, wherein the user computing device 12 are coupled to the computer server 14. This coupling may be a network connection, such as through an Internet connection, a Wi-Fi connection, a Bluetooth connection or the like, wherein the user computing devices 12 may communicate with and receive communication from the server 14. The user computing device 12 may include a desktop computer, a laptop, a tablet, a smartphone and the like. The computer server 14 in some embodiments may be a cloud-based infrastructure architecture.

The computer server 14 may include a memory storing various data. The memory of the computer server 14 may store ticketed experience data such as, but not limited to, ticket codes, pictures, graphics, themes, scores, venue information, player information, musician information, backgrounds, border designs and the like. The memory of the computer server 14 may store ticketed experience data, such as ticket code information for every ticket sold, experience location associated with the ticket code information, seat location associated with the ticket code information, date of the ticketed experience, teams, performers and the like performing in the ticketed experience and specific images related to the ticketed experience.

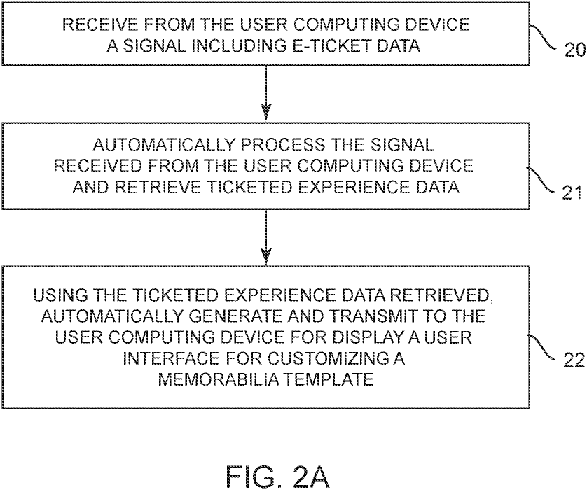

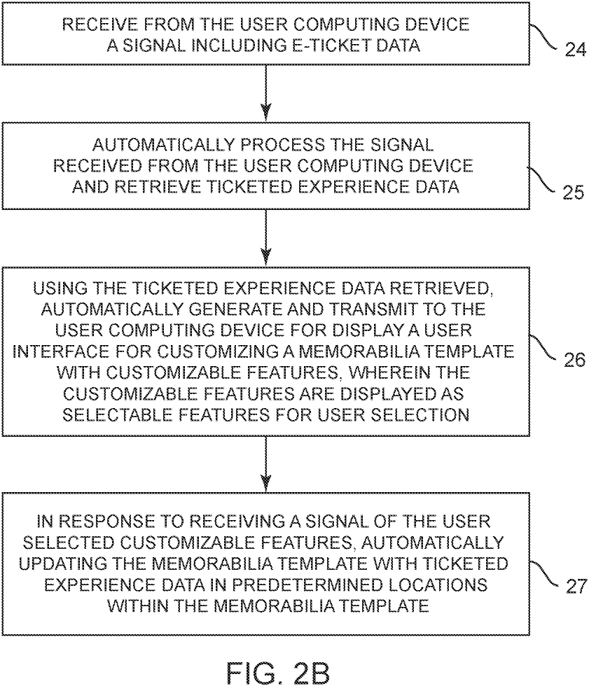

The user computing device 12 may be coupled to the computer server 14,and, referring to FIG. 2, the computer server 14 may be programmed to receive from the user computing device 12 a signal including E-ticket data (Step 20), wherein the E-ticket data may include ticket code information; automatically process the signal received from the user computing device 12 and retrieve ticketed experience data corresponding to the E-ticket data (Step 21); using the ticketed experience data retrieved, automatically generate and transmit to the user computing device for display a user interface for customizing a memorabilia template with customizable features and at least one data element of the ticketed experience data automatically entered within the memorabilia template (Step 22), wherein the customizable portions are customized based on user determination for printing of the customized memorabilia template as a memorabilia item for the ticketed experience corresponding to the E-ticket data. In some embodiments, the at least one data element of the ticketed experience data automatically entered within the memorabilia template may include a location of the ticketed experience, a venue of the ticketed experience, a date of the ticketed experience, and ticket code of the E-ticket and the like. The ticket code may include a barcode or other identifier of a unique E-ticket for a ticketed experience. In embodiments, licensing partnerships with theme parks, leagues, teams, performers, promoters and the like may provide specific templates with certain theme park graphics, logos, character likeness, player likeness, performer likeness and the like.

The user computing device 12 may be coupled to the computer server 14,and, referring to FIG. 2B, the computer server 14 may be programmed to receive from the user computing device 12 a signal including E-ticket data (Step 24), wherein the E-ticket data may include ticket code information; automatically process the signal received from the user computing device 12 and retrieve ticketed experience data corresponding to the E-ticket data (Step 25); using the ticketed experience data retrieved, automatically generate and transmit to the user computing device for display a user interface for customizing a memorabilia template with customizable features, wherein the customizable features are displayed as selectable features for user selection (Step 26); and in response to receiving a signal of the user selected customizable features, automatically updating the memorabilia template with ticketed experience data in predetermined locations within the memorabilia template (Step 27), wherein the computer server is programmed to initiate creation a memorabilia item for the ticketed experience corresponding to the E-ticket data from the customized memorabilia template. Creation of the memorabilia item may include printing or otherwise creating a physical item or may include creation of a digital memorabilia item. In some embodiments, the ticketed experience data may include a location of the ticketed experience, a venue of the ticketed experience, a date of the ticketed experience, and ticket code of the E-ticket and the like. The ticket code may include a barcode or other identifier of a unique E-ticket for a ticketed experience. In embodiments, licensing partnerships with theme parks, leagues, teams, performers, promoters and the like may provide specific templates with certain theme park graphics, logos, character likeness, player likeness, performer likeness and the like.

In the embodiments described in FIGS. 2A and 2B, the memorabilia template may include various configurations of memorabilia templates that are selectable by the user. These various memorabilia templates may include predetermined locations for customizable features, types of customizable features, preselected graphics or images and the like.

In embodiments, the system 10 may include a software application operating on the user computing device 12, such as a mobile app operating on a smartphone, wherein the user computing device 12 may be a smartphone or other mobile computing device or may be a website or web application that is accessible by the user computing device 12 in order to access and operate the system 10. The signal including E-ticket data of Step 20 may be generated in response to taking a screen shot of the E-ticket including the ticket code of the E-ticket and accessing the same by the software application, wherein the software application includes programmed instructions executed by the user computing device 12 to determine E-ticket data from the screen shot of the E-ticket and automatically send the E-ticket data to the computer server. In other embodiments, E-ticket ticket code data may be entered manually using an interface provided in response to operation of the software application on the user computing device 12, wherein the user can insert the number associated with ticket code. Further still, in some embodiments, a link may be provided to the user computing device 12, such as through an email, or at the time of purchase of the ticket or the like, wherein the link is selectable by the user through the user computing device 12. The selection of the link 12 operates to send the signal including E-ticket data.

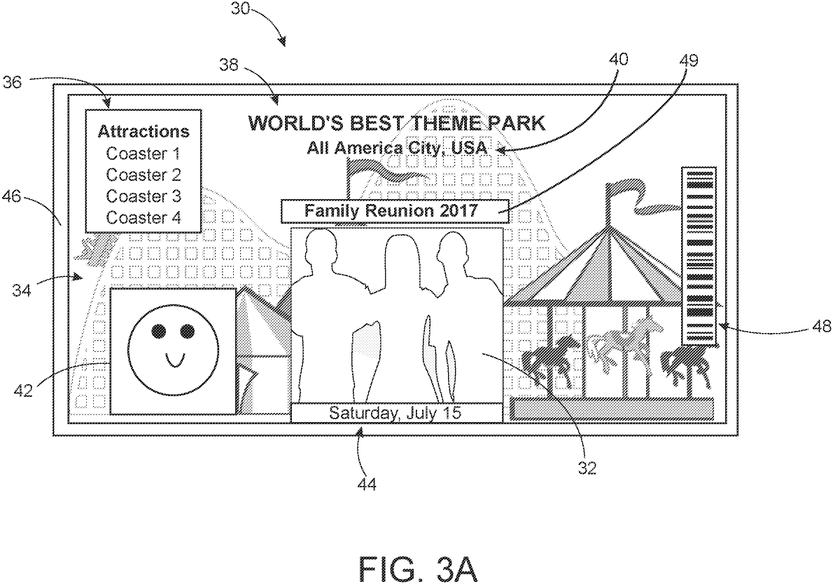

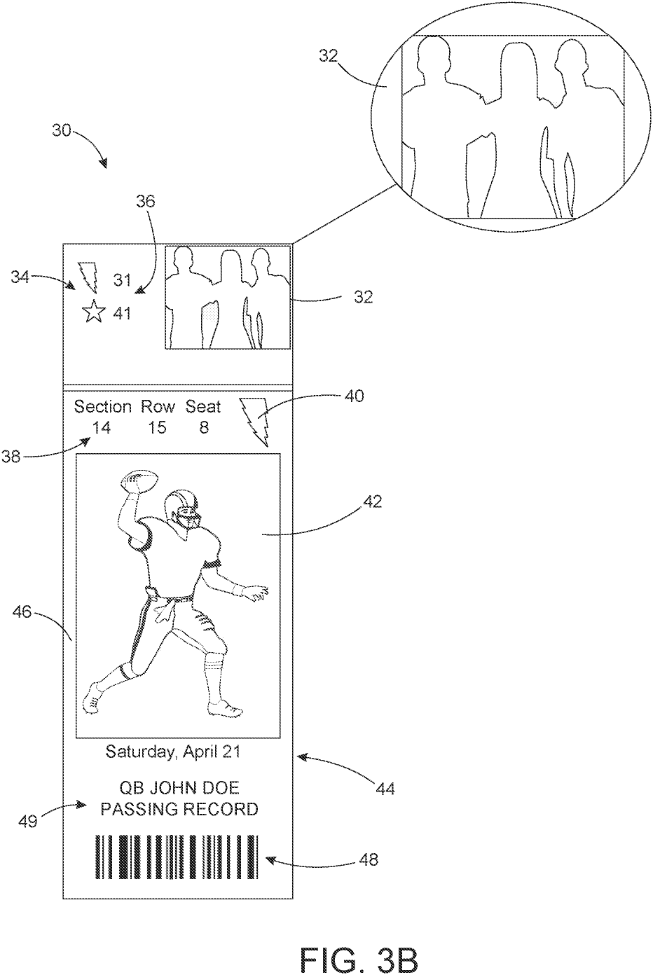

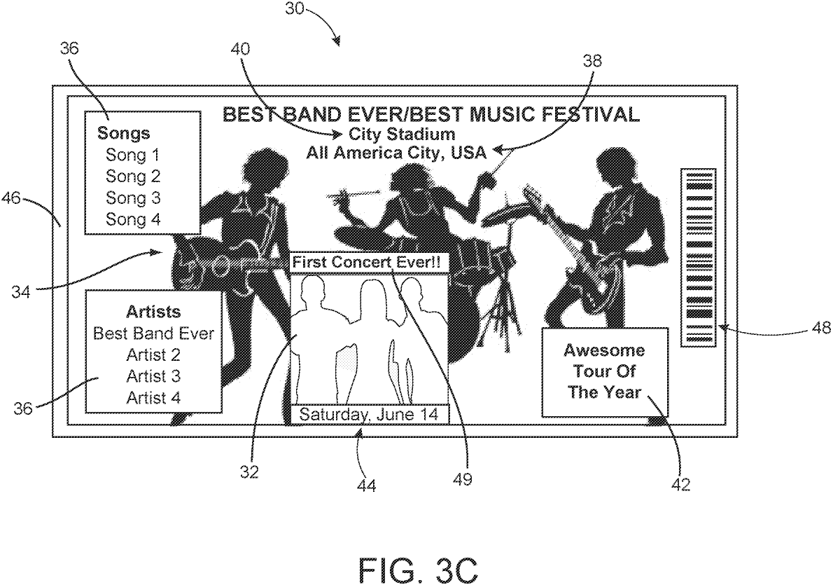

As shown in FIG. 3A, the user interface for customizing a memorabilia item may display a digital version of the memorabilia item as memorabilia template 30 that includes a plurality of various customizable features. As shown, the memorabilia template 30 may be a theme park template, however, this is for exemplary purposes only and other similar types of ticketed experiences may include a similar memorabilia template 30. The customizable features may include, but are not limited to, a user photo feature 32, a graphic feature 34, such as without limitation theme park graphic feature, a ticketed experience specific feature 36, such as without limitation an attractions visited feature, a location feature 38, a venue information feature 40, a ticketed experience specific image feature 42, such as without limitation a character image feature, ride specific image feature, and the like, a date and/or time feature 44, a border feature 46, a ticket code feature 48, and/or a user defined ticketed experience specific feature 49. User defined ticketed experience specific feature 49 may be an editable feature, such as a text box or the like and allows the user to input information that may include a first visit to a theme park, family reunion at a theme park, holiday at a theme park, and the like. The user may modify these customizable features to create a unique memorabilia item and order the same for printing or other form of creation of the memorabilia item. For example, there may be several different character images 42 that are approved for use on the memorabilia item and the user can select the desired character image(s) 42. Additionally, the user photo feature 32 may be filled with an uploaded photo by the user, such as a photo of the user at the theme park or other ticketed experience venue. In embodiments, the software application operating on a user computing device 12, which may be a mobile computing device, may operate to automatically upload a photo taken with a camera of the mobile computing device into the user photo feature 32 of the memorabilia template 30.

As shown in FIG. 3B, the user interface for customizing a memorabilia item may display a digital version of the memorabilia item as memorabilia template 30 that includes a plurality of customizable features. As shown, the memorabilia template 30 may be a sporting event template, however, this is for exemplary purposes only and other similar types of ticketed experiences may include a similar memorabilia template 30. The customizable features may include, but are not limited to, a user photo feature 32, a graphic feature 34, such as without limitation a team logos feature, a ticketed experience specific feature 36, such as without limitation a game score feature, a location feature 38, such as without limitation a seat location feature, a venue information feature 40, a ticketed experience specific image feature 42, a date and/or time feature 44, a border feature 46, a ticket code feature 48, a user defined ticketed experience specific feature 49. User defined ticketed experience specific feature 49 may include records set in a sporting event (i.e. - no hitter, scoring record, home run record, touchdown passes, assist record, and the like), a players first game, a players last game, and/or the like. The user may modify these customizable features to create a unique memorabilia item and order the same for printing or other form of creation of the memorabilia item. For example, there may be several different team images 42 that are approved for use on the memorabilia item and the user can select the team image. Additionally, the user photo feature 32 may be filled with an uploaded photo by the user, such as a photo of the user at the game. In embodiments, the software application operating on a user computing device 12, which may be a mobile computing device, may operate to automatically upload a photo taken with a camera of the mobile computing device into the user photo feature 32 spot of the memorabilia template 30.

As shown in FIG. 3C, the user interface for customizing a memorabilia item may display a digital version of the memorabilia item as memorabilia template 30 that includes a plurality of various customizable features. As shown, the memorabilia template 30 may be a concert template, however, this is for exemplary purposes only and other similar types of ticketed experiences may include a similar memorabilia template 30. The customizable features may include, but are not limited to, a user photo feature 32, a graphic feature 34, such as without limitation a performer graphic feature, a ticketed experience specific feature 36, such as without limitation a songs performed list feature, an artist list feature, or combinations thereof, a location feature 38, a venue information feature 40, a ticketed experience specific image feature 42, such as without limitation a concert identifying image feature, a date and/or time feature 44, a border feature 46, a ticket code feature 48, and/or a user defined ticketed experience specific feature 49. User defined ticketed experience specific feature 49 may be an editable feature, such as a text box or the like and allows the user to input information that may include special performance (i.e. - new song performed for the first time, and the like), a first concert ever, and the like. The user may modify these customizable features to create a unique memorabilia item and order the same for printing or other form of creation of the memorabilia item. For example, there may be several different performer graphic features 34 that are approved for use on the memorabilia item and the user can select the desired performer image(s) 34. Additionally, the user photo feature 32 may be filled with an uploaded photo by the user, such as a photo of the user at the concert or other ticketed experience venue. In embodiments, the software application operating on a user computing device 12, which may be a mobile computing device, may operate to automatically upload a photo taken with a camera of the mobile computing device into the user photo feature 32 of the memorabilia template 30.

As seen in FIGS. 3A-3C, various memorabilia templates 30 may be provided that have customizable information in various locations and may allow the user to determine the type and location of the customizable information for display and creation on the memorabilia item.

The customizations may also include advertisements and any other customization that the entity providing the services wishes to provide. This gives the user the ability to customize a hard stock ticket in a unique manner and further to produce a hard stock ticket accurately tied to the game that the user attended.

In embodiments, the E-ticket data may include validation information for validating the E-ticket is an actual E-ticket for the event, such as but not limited to, a ticket code, a ticket code corresponding numeric or alpha-numeric code, confirmation number and the like that is unique to the ticket or tickets purchased or receive by the user. This unique E-ticket data is useable by the system 10 to verify that the E-ticket for the event is an actual ticket event ticket and not a fraud. This may then be used for authentication purposes if needed, including providing an authentication certificate with the hard stock ticket. This invention is applicable for all ticket required events and locations, such as a sporting event, a concert, a theme park, a venue, and the like.

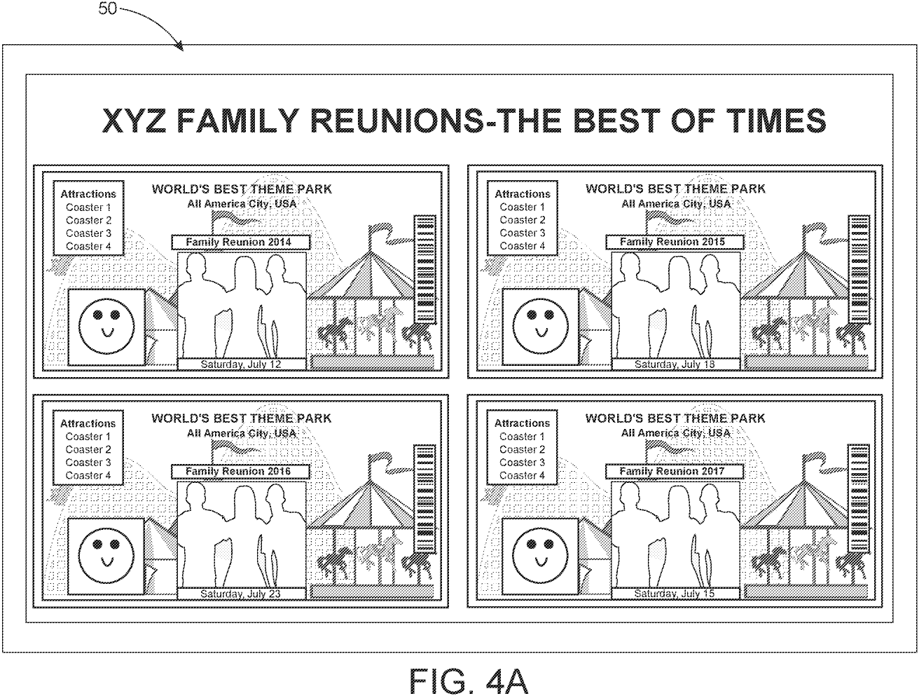

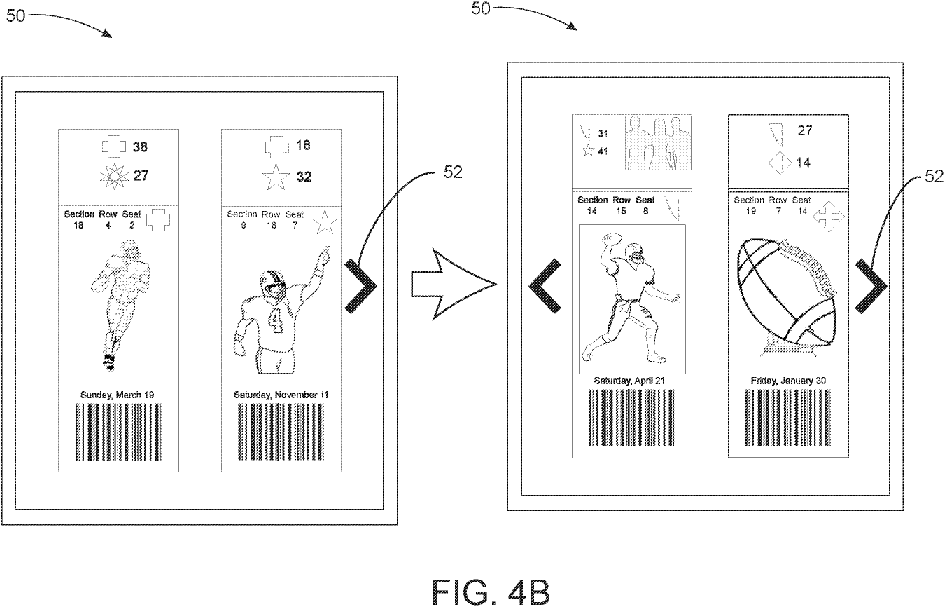

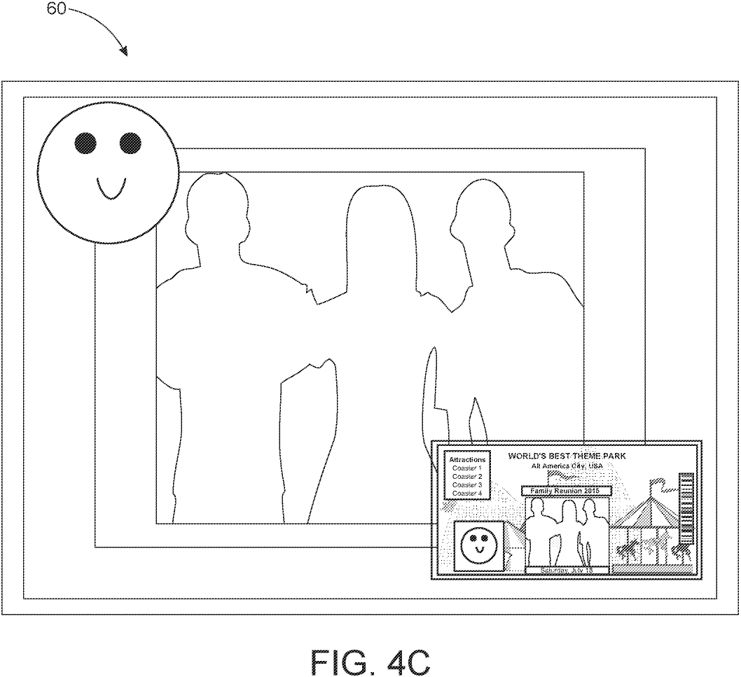

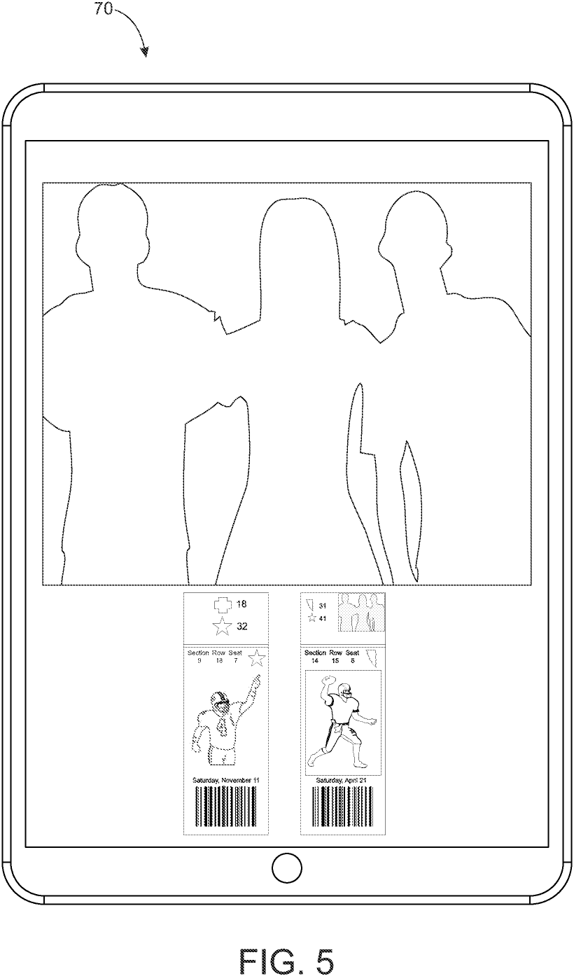

In an alternate embodiment shown in FIGS. 4A-5, the system 10 may produce a digital customization of the memorabilia item and produce the same as a digital file product for display in an electronic picture frame 50, such as electronic picture frame 50 shown in FIG. 4A, and the like. In some embodiments, as shown in FIG. 4B, the digital picture frame may include an active border, such as scrolling text and the like, and may include several screens that can display different or multiple memorabilia items, such as tickets, wherein in some embodiments, a touch screen may be implemented and a user can use her finger to move between screens, a user may select navigation arrows 52 to scroll between screens displaying different memorabilia items, or the frame may be set to auto-scroll through the various displays of memorabilia items. The same process of automating creation of the memorabilia template 30 and selecting customization features may be utilized as described previously. Additionally, other customizations may be presented specifically for the digital format, adding more customization, such as a plurality of tickets, additional photos, and the like. Further, the digital customizable memorabilia item using the system 10 may all be stored in the same electronic picture frame 50 and can be cycled through to view all ticketed experiences memorialized using the system 10, such as, but not limited to all visits to a theme park, a season of tickets, a playoff series of tickets, tickets to the same artist and the like. Additionally, hard stock tickets may be produced using the system and presented to the user in a framed memorabilia item 60 as depicted in FIG. 4C. Additionally, the system 10 may provide the ability to scan old tickets or search a system for tickets from previous years and to include tickets from events attended in the past as part of the memorabilia displayed in electronic picture frame 50.

In some embodiments, the system 10 may include a mobile application that operates to create a unique display on a mobile device 70, such as a smartphone, a tablet or the like, as depicted in FIG. 5. The same process of automating and selecting customization features may be utilized as described previously.

In embodiments, the mobile application may be paired with electronic picture frames to allow for customizable displays. The mobile application may be programmed to allow certain displays involving both tickets, pictures, and/or scores to be created. The mobile application may allow for certain collage configurations wherein the collage configurations may be user defined or may include templates for pictures and tickets to be inserted into. Further still, the mobile application may be a standalone app that would combine image creation with a slideshow function that would work with mobile computing devices. This allows the user use of the system 10 without the need of purchasing an electronic frame to display his or her tickets.

Embodiments may be available on or through the internet, such as through domain names reserved and owned by Applicant that include ticketedexperience.com, ticketyourway.com, savethatticket.com, besttimeevertickets.com, besttimeevertix.com, myhardticket.com, myhardtickets.com, printedtix.com, or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A customizable ticket memorabilia system comprising:
a computer server comprising a memory storing ticket memorabilia templates and ticketed experience data associated with the ticket memorabilia templates; and
a user computing device of a user, wherein the user is an E-ticket holder, coupled to the computer server, the computer server programmed to:
receive from the user computing device a signal including E-ticket data, wherein the E-ticket data comprises ticket code information, and wherein the signal including E-ticket data is generated by one of scanning the E-ticket, entering ticket identifying information in the user computing device, sending a photo, screenshot or scanned image of the E-ticket, logging into a ticket account, or selecting a link received digitally from the system;
automatically process the signal received from the user computing device and retrieve ticketed experience data corresponding to the E-ticket data;
using the ticketed experience data retrieved, automatically generate and transmit to the user computing device for display a user interface for customizing a ticket memorabilia template corresponding to the retrieved ticketed experience data with at least two customizable features comprising a user photo feature, a graphic feature, the at least two customizable features located within the ticket memorabilia template and at least one data element of the ticketed experience data automatically entered within the ticket memorabilia template corresponding to at least one data element of the ticketed experience data
customize the ticket memorabilia template in response to receiving a user photo for the user photo feature and a desired graphic for the graphic feature for creation of a hard stock ticket for the ticketed experience corresponding to the E-ticket data, wherein the ticket memorabilia system is in operation before, during and after a ticketed event, and wherein after the ticketed event comprises past years;
verify that the E-ticket for the event is an actual ticket event ticket and not a fraud;
produce the hard stock ticket for the ticketed experience corresponding to the E-ticket data from the customized ticket memorabilia template; and
providing an authentication certificate with the hard stock ticket.

2. The system of claim 1, wherein the ticketed experience data comprises the ticket code information for every ticket sold, seat location associated with the ticket code information, date of the event, event specific information, specific images related to the event, or combinations thereof.

3. The system of claim 1, wherein the customizable features further comprises one or more of a location feature, a venue information feature, a date/time feature, a border feature, a ticket code feature, or a user defined ticketed experience specific feature.

4. The system of claim 3, wherein at least one data element of the ticketed experience data automatically entered within the ticket memorabilia template includes a location of the ticketed experience in the location feature, a venue of the ticketed experience in the venue information feature, a date of the ticketed experience in the date/time feature, and ticket code of the E-ticket in the ticket code feature.

5. The system of claim 3, wherein the computer server is further programmed to receive a signal including user data and automatically storing the user data in the memory of the computer server.

6. The system of claim 5, wherein the computer server is further programmed to provide the user data to a user computing device for use and placement within the ticket memorabilia template.

7. The system of claim 2, wherein the computer server is further programmed to automatically validate that the E-ticket data sent from the user computing device corresponds to an E-ticket sold for the event in response to comparing the E-ticket data with the ticket code information for every ticket sold to determine a match of the E-ticket data with one of the ticket code information for a ticket stored in the memory of the computer server.
